(19) United States
(12) Patent Application Publication
(10) Pub. No.: US 2006/0270586 A1
(43) Pub. Date: Nov. 30, 2006

(54) Cleaning wipe comprising microcapsules, a kit and a method of use thereof

(75) Inventors: Glenn Thomas Jordan IV, Indian Springs, OH (US); Daniel Dale Ditullio, Hamitlton, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(73) Assignee: The Procter & Gamble Company

(21) Appl. No.: 11/442,868

(22) Filed: May 30, 2006

Related U.S. Application Data
(60) Provisional application No. 60/685,944, filed on May 31, 2005.

(51) Int. Cl. C11D 17/00

(52) U.S. Cl. 510/439

(57) ABSTRACT

The present invention relates to a cleaning wipe suitable for cleaning a surface comprising a cleaning substrate, and microcapsules comprising an active ingredient. The majority of the microcapsules are located adjacent to at least one point on the perimeter of said cleaning substrate. The present invention also relates to (1) a cleaning kit suitable for cleaning a surface, comprising the cleaning wipe and a cleaning implement, and (2) a method of cleaning a surface, comprising the step of contacting the surface with the cleaning wipe.

### CROSS REFERENCE TO RELATED APPLICATION

This application claims the benefit of U.S. Provisional Application No. 60/685,944, filed May 31, 2005.

### FIELD OF THE INVENTION

The present invention relates to a cleaning wipe suitable for cleaning hard surfaces comprising microcapsules, cleaning kits comprising the cleaning wipe, and methods of use thereof.

### BACKGROUND OF THE INVENTION

Cleaning wipes comprising microcapsules are well known in the art. For example, WO 01/73188 (Givaudan) describes a disposable cleaning cloth having microcapsules containing an odoriferous liquid active ingredient, fixed to its surface. The cloth provides a long-lasting active ingredient release in the air, and burst-like active transfer of perfume when a surface is wiped. EP-A-1410753 (3M) describes an abrasive cleaning article comprising a three-dimensional nonwoven web of fibers, and 10-250 μm microcapsules containing an aromatizing substance bonded to the web by a resin adhesive. GB 1374272 (Johnson & Johnson) describes a disposable cleaning pad comprising an absorbent filler and rupturable perfume capsules. The capsules can have a water-soluble shell to release the perfume upon dissolution.

WO 00/27271 (The Procter & Gamble Company) describes cleaning pads containing moisture-activated encapsulated perfume particles. The particles are made of cyclodextrin or of a polysaccharide/polyhydroxy cellular matrix, and are preferably incorporated in the absorbent layer of the pad. Only when the liquid is absorbed into the absorbent layer, the particles are triggered to release perfume. As it requires some time before the liquid is absorbed into the absorbent layer, the perfume is thus not immediately released from the moisture-activated particles. Furthermore, since the particles are incorporated inside the absorbent layer, the particles are protected by the absorbent layer and the surrounding layers of the pad. As a result, lots of particles are in fact prevented from rupturing, and do not release perfume. Also, the rather thick structure of the cleaning pad prevents the perfume to be easily released into the air, and prevents transfer of microcapsules to the surface. It has also been found that cyclodextrin or polysaccharide/polyhydroxy cellular matrix capsules, when they would be transferred to a surface, result in streaking when wiping the surface. WO 00/27271 also teaches that, when a wipe is attached to a cleaning implement, most pressure can be applied to the center of the wipe.

The cleaning wipes of the prior art do not provide optimum release of the active ingredients from the microcapsules during use. This is because the microcapsules are not optimally located on the wipe. As such, many of the microcapsules actually do not release the active ingredient contained therein, or are not transferred to the surface.

Accordingly, it is an object of the present invention to provide a cleaning wipe with improved release of the active ingredient from the microcapsules, and which is capable of transferring more microcapsules to the surface, during use.

### SUMMARY OF THE INVENTION

According to a first aspect, the present invention relates to a cleaning wipe suitable for cleaning a surface comprising:
(a) a cleaning substrate; and
(b) microcapsules comprising an active ingredient;
   characterized in that the majority of said microcapsules are located adjacent to at least one point on the perimeter of said cleaning substrate.

According to a second aspect, the present invention relates to a cleaning kit suitable for cleaning a surface, comprising:
(a) a cleaning implement; and
(b) a cleaning wipe of the present invention.

According to a third aspect, the present invention relates to a method of cleaning a surface, comprising the step of contacting the surface with the cleaning wipe of the present invention.

### BRIEF DESCRIPTION OF THE DRAWINGS

FIG. 1 shows an underside view of a preferred cleaning wipe of the present invention.

FIG. 2 shows a side view of another preferred cleaning wipe of the present invention.

FIG. 3 shows a perspective view of a cleaning implement for use with the cleaning wipe of the present invention.

### DETAILED DESCRIPTION

### I. Cleaning Wipe

The cleaning wipe according to the present invention comprises a cleaning substrate, and microcapsules comprising an active ingredient. The cleaning wipe of the present invention is preferably disposable. By the term disposable it is meant that the wipe is designed for use for a single cleaning task, or a small number (typically less than 3) of cleaning tasks only, and is then preferably discarded. The cleaning wipe of the present invention can be used for example for dry dusting of hard surfaces, but is preferably used in combination with a cleaning composition for wet cleaning of hard surfaces, such as floors, sinks, bathtubs, shower walls, glass, kitchen surfaces, cars and the like.

The cleaning wipe according to the present invention may further comprise one or more additional attachment means for attaching the wipe to a cleaning implement. Suitable attachment means are, but not limited to, one or more protrusions in the wipe (which would correspond to pin(s) on the mop head), hook or loop fasteners, adhesives, straps, or any other suitable attachment means known in the art, or any combinations thereof. This also includes attachment means, of which part of the attachment means is located on the wipe, and a corresponding part of the attachment means is located on the cleaning implement's mop head, such as e.g. press-stud systems.

In a preferred embodiment, the additional attachment means is an attachment layer that allows the wipe to be connected to a cleaning implement's mop head. The attachment layer will be necessary in those embodiments where the cleaning substrate is not suitable for attaching the wipe to the mop head of the implement. The attachment layer may also function as a means to reduce or prevent fluid flow through the upper surface of the cleaning substrate, and may further provide enhanced integrity of the substrate. The attachment layer may consist of a mono-layer or a multi-layer structure, so long as it meets the above requirements. It is preferred that a laminated structure comprising, e.g., a meltblown film and fibrous, nonwoven structure be utilized. In a preferred embodiment, the attachment layer is a spun-bonded polypropylene. The attachment layer is attached to the upper surface of the cleaning substrate, and has a surface equal to, or larger than the cleaning substrate's upper surface.

The cleaning wipe will now be explained in more detail.

### II. Cleaning Substrate

The cleaning wipe according to the present invention comprises a cleaning substrate. To be clear, the definition of cleaning substrate does not include an attachment means or attachment layer. The cleaning substrate preferably comprises nonwoven fibers or paper. The term nonwoven is to be defined according to the commonly known definition provided by the “Nonwoven Fabrics Handbook” published by the Association of the Nonwoven Fabric Industry. A paper substrate is defined by EDANA (note 1 of ISO 9092-EN 29092) as a substrate of which more than 50% by mass of its fibrous content is made up of fibers (excluding chemically digested vegetable fibers) with a length to diameter ratio of greater than 300, and more preferably also has density of less than 0.040 g/cm³. To be clear, the definitions of both nonwoven and paper substrates do not include woven fabric or cloth or sponge.

The cleaning substrate may comprise fibers that are naturally occurring (modified or unmodified), as well as synthetically made fibers. Natural fibers include all those, which are naturally available without being modified, regenerated or produced by man and are generated from plants, animals, insects or by-products of plants, animals and insects. Examples of suitable unmodified/modified naturally occurring fibers include cotton, Esparto grass, bagasse, kemp, flax, silk, wool, wood pulp, chemically modified wood pulp, jute, ethyl cellulose, cellulose acetate, and combinations thereof. As used herein, “synthetic” means that the materials are obtained primarily from various man-made materials or from natural materials that have been further altered. Nonlimiting examples of synthetic materials useful in the present invention include those selected from the group consisting of acetate fibers, acrylic fibers, cellulose ester fibers, modacrylic fibers, polyamide fibers, polyester fibers, polyolefin fibers, polyvinyl alcohol fibers, rayon fibers and combinations thereof. Examples of suitable synthetic materials include acrylics such as acrilan, creslan, and the acrylonitrile-based fiber, orlon; cellulose ester fibers such as cellulose acetate, arnel, and acele; polyamides such as nylons (e.g., nylon 6, nylon 66, nylon 610, and the like); polyesters such as fortrel, kodel, and the polyethylene terephthalate fiber, polybutylene terephalate fiber, dacron; polyolefins such as polypropylene, polyethylene; polyvinyl acetate fibers and combinations thereof. These and other suitable fibers and the nonwovens prepared therefrom are generally described in Riedel, “Nonwoven Bonding Methods and Materials,” Nonwoven World (1987); The Encyclopedia Americana, vol. 11, pp. 147-153, and vol. 26, pp. 566-581 (1984). Suitable synthetic materials may include solid single component (i.e., chemically homogeneous) fibers, multiconstituent fibers (i.e., more than one type of material making up each fiber), and multicomponent fibers (i.e., synthetic fibers which comprise two or more distinct filament types which are somehow intertwined to produce a larger fiber), and combinations thereof. Such bicomponent fibers may have a core-sheath configuration or a side-by-side configuration. Suitable bicomponent fibers for use in the present invention can include sheath/core fibers having the following polymer combinations: polyethylene/poly-propylene, polyethylvinyl acetate/polypropylene, poly-ethylene/polyester, polypropylene/polyester, copolyester/polyester, and the like. Particularly suitable bicomponent thermoplastic fibers for use herein are those having a polypropylene or polyester core, and a lower melting copolyester, polyethylvinyl acetate or polyethylene sheath (e.g., those available from Danaklon a/s and Chisso Corp.). These bicomponent fibers can be concentric or eccentric. As used herein, the terms “concentric” and “eccentric” refer to whether the sheath has a thickness that is even, or uneven, through the cross-sectional area of the bicomponent fiber. Eccentric bicomponent fibers can be desirable in providing more compressive strength at lower fiber thicknesses. Preferred bicomponent fibers comprise a copolyolefin bicomponent fiber comprising less than about 81% polyethylene terephthalate core and a less than about 51% copolyolefin sheath. The amount of bicomponent fibers will preferably vary according to the density of the material in which it is used.

Methods of making nonwovens are well known in the art. Generally, these nonwovens can be made by air-laying, water-laying, meltblowing, coforming, spunbonding, or carding processes in which the fibers or filaments are first cut to desired lengths from long strands, passed into a water or air stream, and then deposited onto a screen through which the fiber-laden air or water is passed. The resulting layer, regardless of its method of production or composition, is then subjected to at least one of several types of bonding operations to anchor the individual fibers together to form a self-sustaining substrate. In the present invention the nonwoven substrate can be prepared by a variety of processes including, but not limited to, air-entanglement, hydro-entanglement, thermal bonding, carding, needle-punching, or any other process known in the art, and combinations of these processes. However, a nonwoven substrate may also be described as a thermoplastic formed film.

The cleaning substrate is preferably partially or fully permeable to water and an aqueous hard surface cleaning composition.

The cleaning substrate of the cleaning wipe can be mono-layered, but is preferably multi-layered and comprises an upper and a lower layer. The layers are bonded together to form a unitary structure. The layers can be bonded in a variety of ways including, but not limited to, adhesive bonding, thermal bonding, ultra sonic bonding, and the like. The layers can be assembled to form a substrate either by hand or by a conventional line converting process known in the art.

According to a preferred embodiment of the present invention, the substrate comprises an absorbent layer, and optionally a scrubbing layer. This cleaning substrate is particularly designed for cleaning floors or other hard surfaces, and is preferably used in combination with an aqueous cleaning composition suitable for cleaning floors.

The absorbent layer comprises any material capable of absorbing and retaining fluid during use. It is preferred that the absorbent layer is sandwiched between an upper layer and a lower layer. Typically, the absorbent layer comprises nonwoven fibrous material. The absorbent layer can comprise solely naturally occurring fibers, solely synthetic fibers, or any compatible combination of naturally occurring and synthetic fibers. The fibers useful herein can be hydrophilic, hydrophobic or can be a combination of both hydrophilic and hydrophobic fibers. As used herein, the term “hydrophilic” is used to refer to surfaces that are wettable by is aqueous fluids deposited thereon. Hydrophilicity and wettability are typically defined in terms of contact angle and the surface tension of the fluids and solid surfaces involved. This is discussed in detail in the American Chemical Society publication entitled “Contact Angle, Wettability and Adhesion”, edited by Robert F. Gould (Copyright 1964). A surface is said to be wetted by a fluid (i.e., hydrophilic) when either the contact angle between the fluid and the surface is less than 90°, or when the fluid tends to spread spontaneously across the surface, both conditions normally co-existing. Conversely, a surface is considered to be “hydrophobic” if the contact angle is greater than 90° and the fluid does not spread spontaneously across the surface. The particular selection of hydrophilic or hydrophobic fibers will depend upon the other materials included in the cleaning substrate, for instance in different absorbent layers. That is, the nature of the fibers will be such that the cleaning substrate exhibits the necessary fluid delay and overall fluid absorbency. Suitable hydrophilic fibers for use in the present invention include cellulosic fibers, modified cellulosic fibers, rayon, polyester fibers such as hydrophilic nylon (HYDROFIL®). Suitable hydrophilic fibers can also be obtained by hydrophilizing hydrophobic fibers, such as surfactant-treated or silica-treated thermoplastic fibers derived from, for example, polyolefins such as polyethylene or polypropylene, polyacrylics, polyamides, polystyrenes, polyurethanes and the like. Suitable wood pulp fibers can be obtained from well-known chemical processes such as the Kraft and sulfite processes. It is especially preferred to derive these wood pulp fibers from southern soft woods due to their premium absorbency characteristics. These wood pulp fibers can also be obtained from mechanical processes, such as ground wood, refiner mechanical, thermomechanical, chemimechanical, and chemi-thermomechanical pulp processes. Recycled or secondary wood pulp fibers, as well as bleached and unbleached wood pulp fibers, can be used. Another type of hydrophilic fiber for use in the absorbent layer is chemically stiffened cellulosic fibers. As used herein, the term “chemically stiffened cellulosic fibers” means cellulosic fibers that have been stiffened by chemical means to increase the stiffness of the fibers under both dry and aqueous conditions. Such means can include the addition of a chemical stiffening agent that, for example, coats and/or impregnates the fibers. Such means can also include the stiffening of the fibers by altering the chemical structure, e.g., by crosslinking polymer chains.

The absorbent layer preferably has a basis weight of from 60 g/m² to 300 g/m², more preferably from 80 g/m² to 200 g/m², most preferably from 90 g/m² to 160 g/m². It is preferably composed of from 70% to 90% wood pulp fibers or other cellulosic materials, 1% to 30% binders, and 1% to 30% of bicomponent fibers.

Where the cleaning substrate comprises an upper layer and a lower layer, they too may comprise any of the above absorbent materials, or may be non-absorbent but fluid pervious in nature. If the upper and/or lower layer is absorbent, it will typically have lower absorbency than the absorbent layer. The upper layer and the lower layer may comprise separate layer materials, or may be portions of the same layer material, for instance which is wrapped around the absorbent layer. Furthermore, the upper layer and lower layer may each independently comprise a monolayer or multi-layer structure, and additional components may be included between the upper and/or lower layer and the absorbent layer.

The optional, but preferred, scrubbing layer is the portion of the cleaning substrate that contacts the soiled surface during cleaning, i.e. is the lower layer of the cleaning substrate. As such, materials useful as the scrubbing layer must be sufficiently durable that the layer will retain its integrity during the cleaning process. In addition, when the cleaning substrate is used in combination with a solution, the scrubbing layer must be capable of absorbing liquids and soils, and relinquishing those liquids and soils to the absorbent layer. This will ensure that the scrubbing layer will continually be able to remove additional material from the surface being cleaned. Whether the implement is used with a cleaning solution (i.e., in the wet state) or without cleaning solution (i.e., in the dry state), the scrubbing layer will, in addition to removing particulate matter, facilitate other functions, such as polishing, dusting, and buffing the surface being cleaned. The scrubbing layer can be a monolayer, or a multi-layer structure one or more of whose layers may be slitted to faciliate the scrubbing of the soiled surface and the uptake of particulate matter. This scrubbing layer, as it passes over the soiled surface, interacts with the soil (and cleaning solution when used), loosening and emulsifying tough soils and permitting them to pass freely into the absorbent layer of the substrate. The scrubbing layer preferably contains openings (e.g., slits) that provide an easy avenue for larger particulate soil to move freely in and become entrapped within the absorbent layer of the wipe. Low-density structures are preferred for use as the scrubbing layer, to facilitate transport of particulate matter to the wipe's absorbent layer.

A wide range of materials is suitable for use in the scrubbing layer, for instance as disclosed in WO-A-0027271. In particular, the scrubbing layer may comprise woven and nonwoven materials; polymeric materials such as apertured formed thermoplastic films, apertured plastic films, and hydroformed thermoplastic films; porous foams; reticulated foams; reticulated thermoplastic films; and thermoplastic scrims. Suitable woven and nonwoven materials can comprise natural fibers (e.g., wood or cotton fibers), synthetic fibers such as polyolefins (e.g., polyethylene, particularly high density polyethylene, and polypropylene), polyesters (e.g., polyethylene terephthalate), polyimides (e.g., nylon) and synthetic cellulosics (e.g., RAYON®, polystyrene, and blends and copolymers thereof, and combinations of natural and synthetic fibers.

The scrubbing layer may comprise, at least in part, an apertured-formed film. Apertured-formed films are preferred for the liquid pervious scrubbing layer because they are pervious to aqueous cleaning liquids containing soils, including dissolved and undissolved particulate matter, yet are non-absorbent and have a reduced tendency to allow liquids to pass back through and rewet the surface being cleaned. Thus, the surface of the formed film which is in contact with the surface being cleaned remains dry, thereby reducing filming and streaking of the surface being cleaned and permitting the surface to be wiped substantially dry. An apertured formed film having tapered or funnel-shaped apertures, meaning that the diameter at the lower end of the aperture is greater than the diameter at the upper end of the aperture, actually exhibits a suctioning effect as the cleaning substrate is moved across the surface being cleaned. This aids in moving liquid from the surface being cleaned to other layers of the cleaning substrate, such as the absorbent layer(s). In addition, tapered or funnel-shaped apertures have an even greater tendency to prevent liquids from passing back through the scrubbing layer to the surface being cleaned once they have been transferred to other layers, such as the absorbent layer(s). Apertured-formed films having tapered or funnel-shaped apertures are thus preferred. Suitable apertured-formed films are described in U.S. Pat. No. 3,929,135, entitled “Absorptive Structures Having Tapered Capillaries”, which issued to Thompson on Dec. 30, 1975; U.S. Pat. No. 4,324,246 entitled “Disposable Absorbent Article Having A Stain Resistant Topsheet”, which issued to Mullane et al. on Apr. 13, 1982; U.S. Pat. No. 4,342,314 entitled “Resilient Plastic Web Exhibiting Fiber-Like Properties”, which issued to Radel at al. on Aug. 3, 1982; U.S. Pat. No. 4,463,045 entitled “Macroscopically Expanded Three-Dimensional Plastic Web Exhibiting Non-Glossy Visible Surface and Cloth-Like Tactile Impression”, which issued to Ahr et al. on Jul. 31, 1984; and U.S. Pat. No. 5,006,394 entitled “Multilayer Polymeric Film” issued to Baird on Apr. 9, 1991. The preferred liquid pervious scrubbing layer for the present invention is the apertured-formed film described in one or more of the above patents and marketed on sanitary napkins by The Procter & Gamble Company of Cincinnati, Ohio as DRI-WEAVE®.

Although a hydrophilic apertured-formed film can be used as a liquid pervious scrubbing layer of a substrate, in the context of hard surface cleaning, a hydrophobic apertured-formed film is preferred since it will have a reduced tendency to allow liquids to pass back through the scrubbing layer and onto the surface being cleaned. This results in improved cleaning performance in terms of filming and streaking, lower soil residue, and faster drying time of the surface being cleaned, all of which are very important aspects of hard surface cleaning. The liquid pervious scrubbing layer of the present cleaning substrate is thus preferably a hydrophobic apertured-formed film, at least in part. It is also recognized that the scrubbing layer can be comprised of more than one type of material.

In a preferred embodiment, the liquid pervious scrubbing layer is a macroscopically expanded three-dimensional plastic web, preferably having protruberances, or surface aberrations, on the lower surface of the scrubbing layer which, in use, contacts the hard surface being cleaned. As used herein, the term “macroscopically expanded”, when used to describe three-dimensional plastic webs, ribbons, and films, refers to webs, ribbons, and films which have been caused to conform to the surface of a three-dimensional forming structure so that both surfaces thereof exhibit the three-dimensional pattern of said forming structure, said pattern being readily visible to the naked eye when the perpendicular distance between the viewer's eye and the plane of the web is about 12 inches (about 30 cm). Such macroscopically expanded webs, ribbons and films are typically caused to conform to the surface of said forming structures by embossing, i.e., when the forming structure exhibits a pattern comprised primarily of male projections, by debossing, i.e., when the forming structure exhibits a pattern comprised primarily of female capillary networks, or by extrusion of a resinous melt directly onto the surface of a forming structure of either type. By way of contrast, the term “planar”, when utilized herein to describe plastic webs, ribbons and films, refers to the overall condition of the web, ribbon or film when viewed by the naked eye on a macroscopic scale. In this context, “planar” webs, ribbons and films can include webs, ribbons and films having fine scale surface aberrations on one or both sides, said surface aberrations not being readily visible to the naked eye when the perpendicular distance between the viewer's eye and the plane of the web is about 12 inches (about 30 cm) or greater. Surface aberrations are created on a plastic web by photoetching techniques well known in the art. A detailed description of such a web and a process for making it is disclosed by Ahr et al., U.S. Pat. No. 4,463,045, issued Jul. 31, 1984 and assigned to The Procter & Gamble Company, which is hereby incorporated by reference. Ahr at al. disclose a macroscopically expanded three-dimensional web having surface aberrations for use as a topsheet in diapers, sanitary napkins, incontinence devices, and the like. Ahr at al. prefer a web having surface aberrations because it imparts a non-glossy appearance to the web and improves the tactile impression of the web by making it feel more cloth-like to the wearer of the diaper, sanitary napkin, etc. However, in the context of hard surface cleaning, appearance and tactile impression of a cleaning substrate are of lesser importance. A liquid pervious scrubbing layer comprising a macroscopically expanded three-dimensional web having surface aberrations results in improved performance of the scrubbing layer. The surface aberrations provide a more abrasive surface, which correlates to better cleaning performance. The surface aberrations, in combination with tapered or funnel-shaped apertures, provide enhanced cleaning, absorbency, and rewet characteristics of the cleaning substrate. The liquid pervious scrubbing layer thus preferably comprises an apertured-formed film comprising a macroscopically expanded three-dimensional plastic web having tapered or funnel-shaped apertures and/or surface aberrations. A three-dimensional scrubbing layer is especially preferable for improving a cleaning substrate's ability to pick-up particulate matter.

The cleaning substrate optionally, but preferably, comprises at least one scrubbing strip, at least one cuff, or a combination thereof.

The scrubbing strip may be a continuous or discontinuous strip of material, or it may comprise localised areas of material, optionally in the form of a pattern. The scrubbing strip necessarily comprises an abrasive material, to remove tough stains. Suitable materials include those often used for making scouring pads, typically polymers or polymer blends with or without specific abrasives. Examples of suitable polymers include thermoplastic polymers such as polypropylene, high density polyethylene, polyesters (eg., polyethylene terephthalate), nylon, polystyrene, polycarbonate, and blends and copolymers thereof.

An alternative to using materials found in typical scouring pads is to use brushes containing bristles to achieve scrubbing. Such bristles are typically composed of polymer or polymer blends, with or without abrasives. In the context of brushes, bristles made of nylon again are preferred because of rigidity, stiffness, and/or durability. A preferred nylon bristle is that commercially available from 3M Corp. under the trade name Tynex® 612 nylon. These bristles have shown less water absorption versus commercial Nylon 66. Another approach is to use netting or scrim materials to form the scrubbing strip. Again, the netting or scrim is typically composed of a polymer or polymer blend, either with or without abrasives. The netting or scrim is typically wrapped around a secondary structure to provide some bulk. The shape of the holes in the netting can include, but is not limited to, a variety of shapes such as squares, rectangles, diamonds, hexagons or mixtures thereof. Typically, the smaller the area composed by the holes in the netting the greater the scrubbing ability. This is primarily due to the fact that there are more points where the scrim material intersects, as it is these intersection points that will contact the floor. An alternative to wrapping netting or scrim is to apply molten extruded polymers directly onto a secondary structure such as a non-woven. Upon solidifying the polymer would create high point stiffer material as compared to the secondary non-woven, and thereby provides scrubbing ability.

Yet another alternative is for the scrubbing strip to comprise abrasive or coarse particulate material. A suitable particulate material comprises coarse inks available from Polytex®. The scrubbing strip may be a monolayer or multilayer structure. Preferred scrubbing layers take the form of film materials, provided that they have the necessary flexural rigidity to withstand repeated scrubbing actions. Suitable film materials generally have a thickness of at least 2 mils and a flexural rigidity of at least 0.10 g cm²/cm, measured using the Kawabata Bending Tester Model KES-FB, from Kato Tech Co., Ltd.

The typical basis weight for flexural stiff materials suitable for use as the scrubbing strip ranges from 20 to 150 g/m², for instance 30 to 125 g/m². However, it is the combination of modulus and thickness that determines flexural rigidity. From a theoretical viewpoint for a rectangular homogeneous isotropic plate or film, the flexural rigidity is calculated from the formula:

$$\frac{{Ebh}^{3}}{12}$$

where E is modulus, b is plate width, and h is plate thickness. This formula indicates the importance of web thickness.

For webs composed of fibers, the relationship is more complex and both the web stiffness and fiber stiffness can be important factors. The flexural rigidity for a single fiber may be calculated from the formula:

$$\frac{π {Ed}^{3}}{32}$$

As indicated in the above formula, the fiber diameter is significant in selecting webs that can be used as the scrubbing strip. Generally, fibers with diameters between 20 and 75 microns are useful. High modulus or tenacity fibers are also an important factor.

Preferred film materials are pervious to liquids, and in particular liquids containing soils, and yet are non-absorbent and have a reduced tendency to allow liquids to pass back through their structure and rewet the surface being cleaned. Thus, the surface of the film tends to remain dry during the cleaning operation, thereby reducing filming and streaking of the surface being cleaned and permitting the surface to be wiped substantially dry.

Preferably the film material comprises a plurality of protrusions extending outwardly from the film surface and away from the body of the cleaning pad. Alternatively, or additionally, the film may comprise a plurality of apertures.

The protrusions and/or apertures formed in the above-described film materials may be of a variety of shapes and/or sizes. For instance, the protrusions may take the form of flaps that extend outwardly from the plane of the film material at an angle thereto. The protrusions may also take the form of teeth that are rectangular, square or triangular in cross-section, or they may comprise domes or conical or frustoconical structures. Optionally, the protrusions may also comprise apertures themselves. The apertures may, for instance, be square, rectangular, triangular, circular, oval and/or hexagonal in shape, or they may take the form of narrow slits. Another option is for the apertures to be tapered or funnel-shaped, such that, preferably, the diameter at the end of the aperture closest the floor in use is greater than the diameter at the opposite end of the aperture, such that the aperture exhibits a suctioning effect as the cleaning pad is moved across the surface being cleaned. In addition, tapered or funnel-shaped apertures prevent liquid passing back from the scrubbing strip to the surface being cleaned.

The protrusions and/or apertures may be arranged in a pattern within the scrubbing strip. If so, the protrusions and/or apertures are preferably staggered relative to adjacent protrusions and/or apertures in order to enhance stain removing ability.

Specific examples of films that may be used as the scrubbing strip now follow:

1) Flexurally rigid film (as defined by the Kawabata Bending Tester mentioned above) having out-of-plane protrusions which may take the form of a rectangular or other shaped tooth capable of abrading hard surfaces without substantial loss of shape. The teeth have walls having at least two opposing faces.

2) Flexurally rigid film (as defined by the Kawabata Bending Tester mentioned above) having a slit structure comprising an overlapping set of cut flaps, with at least one flap that is raised out of the plane of the film, and that are capable of adbrading a hard surface without substantial loss of shape. Both of these types of film are created by passing a thermoplastic film or nonwoven web between counter-rotating rollers comprising intermeshing small discontinuous quasi-rectangular teeth on one roller and continuous teeth on the other roller. The size of the resulting protrusions is similar to the width of the discontinuous teeth. Typically, the protrusions range from 1 to 3 mm in the machine direction and 0.5 to 3 mm in the cross-machine direction. The height of the protrusions may be up to 5 mm.

3) A tufted flexurally rigid nonwoven film where sections of fibres are raised substantially perpendicular to the plane of the film. Typical basis weights lie in the range 20 to 100 g/m², and the fiber diameter is typically greater than 20 μm. Preferred fibers include high tenacity fibers such as PET, nylon and polypropylene. The tufted fibers may be either substantially continuous fibers or substantially broken fibers.

4) A film comprising multi-sided raised structures resembling domes, and which have sufficient structural rigidity to withstand the typical forces exerted during cleaning without permanent deformation. Typically, the dome dimensions are in the range 2 to 10 mm in the cross-machine direction and 2 to 10 mm in the machine direction.

These domes are created by passing a thermoplastic film or nonwoven web between counter-rotating rollers comprising intermeshing small discontinuous quasi-rectangular teeth on one roller and intermeshing larger and patterned discontinuous quasi-retangular teeth on the other roller. The discontinuous teeth on the later roller are made in a pattern such as groups of diamonds. Reference is made in this regard to U.S. Pat. No. 5,518,801 and U.S. Pat. No. 5,968,029. Typically, the protrusions range from 1 to 10 mm in the machine direction, and 1 to 10 mm in the cross-machine direction. The domes typically are apertured by the penetration of the film. The resulting structure is a dome with apertures on one side and a pocket containing one or more tee-pee struts on the other side. This process may be used for both films and nonwovens.

5) Films having apertures which may have a variety of shapes and which may be combined with protrusions, for instance, the apertures may take the form of squares, rectangles, slits, circles, ovals or any other shape. The size of the apertures may vary widely but is typically in the range 0.5 to 10 mm², for instance 0.5 to 5 mm². The resulting films may have 0.5 to 50% open area, typically 0.5 to 5% open area when the film has very small apertures, which may not be visible to the naked eye, or 5 to 40% open area where the film has larger apertures.

6) Films or webs having corrugations, for instance having 1 to 6 folds per 10 mm with fold heights ranging from 0.05 to 3 mm. The corrugations can be prepared by a ring roll lamination process. The films or webs may be apertured.

The scrubbing strip is positioned such that it lies along, and adjacent to an edge of the cleaning substrate. Where the cleaning substrate comprises two longitudinal edges, connected to each other via side edges, it is preferred that the scrubbing strip is positioned along a longitudinal edge, and adjacent to this edge.

In one embodiment, the cleaning substrate may comprise two scrubbing strips, typically arranged to be on opposing edges, preferably longitudinal edges, of the cleaning substrate. These scrubbing layers may comprise the same material, or different materials. It may, in certain instances, be advantageous for the two scrubbing strips to comprise different materials. For instance, one material may be chosen so as to loosen tough stains, and the other to pick up large particles loosened from the stain.

The dimensions of the scrubbing strip can have a significant impact of the ability to remove tough stains and soils. Preferably the scrubbing strip extends substantially the entire length of the respective edge of the cleaning substrate. Typically, the scrubbing strip is rectangular in shape. For instance, the width (or y-dimension) of the scrubbing strip is typically in the range from 5 to 100 mm, preferably from 10 to 60 mm, and most preferably from 15 to 30 mm. The length (or x-dimension) of the scrubbing strip is typically at least 20 mm, and preferably at least 50 mm, and more preferably is at least 100 mm, up to, for instance, 500 mm, and typically up to 300 mm. Most preferably the scrubbing strip extends along the full length of the cleaning substrate.

Also, increasing the z-dimension (thickness) of the scrubbing strip typically results in better tough stain removal. The improvement in tough stain removal by varying the dimensions of the scrubbing strip generally applies to scrubbing strips comprising a variety of materials. In addition, increasing the z-dimension (thickness) of the scrubbing strip, allows one to utilize softer materials, such as nylon without abrasive material, in the scrubbing strip while achieving a similar level of tough stain removal as compared to scrubbing strips comprising harder materials, such as polypropylene.

The cleaning substrate may also include one or more “free-floating” functional cuffs. Such cuffs improve the cleaning performance of the cleaning wipe, by improving particulate pick-up. As a cleaning substrate comprising functional cuff(s) is wiped back and forth across a hard surface, the functional cuff(s) “flip” from side to side, thus picking-up and trapping particulate matter. Cleaning substrates having functional cuff(s) exhibit improved pick-up and entrapment of particulate matter, which are typically found on a hard surface, and have a reduced tendency to redeposit such particulate matter on the surface being cleaned. Functional cuffs can comprise a variety of materials, including, but not limited to, carded polypropylene, rayon or polyester, hydroentangled polyester, spun-bonded polypropylene, polyester, polyethylene, cotton, polypropylene, or blends thereof. Where free-floating functional cuffs are utilized, the material used for the functional cuffs should be sufficiently rigid to allow the cuffs to “flip” from side to side, without collapsing or rolling-over on themselves. Rigidity of the functional cuffs can be improved by using high basis weight materials (e.g., materials having a basis weight of greater than about 30 g/m²) or by adding other materials to enhance rigidity such as scrim, adhesives, elastomers, elastics, foams, sponges, scrubbing layers, and the like, or by laminating materials together. Preferably, the functional cuffs comprise a hydroentangled substrate including, but not limited to, polyester, cotton, polypropylene, and mixtures thereof, having a basis weight of at least about 20 g/m² and a scrim material for stiffening. The functional cuffs can be in the form of a mono-layer or a laminate structure, and in the form of a loop or a non-loop structure. One or more functional cuff(s) can be applied to, or formed as an integral part of, cleaning substrate in a variety of locations. The cuff is positioned such that it lies along, and adjacent to an edge of the cleaning substrate. Where the cleaning substrate comprises two longitudinal edges, connected to each other via side edges, it is preferred that the cuff is positioned along a longitudinal edge, and adjacent to this edge. In one embodiment, the cleaning substrate comprises two cuffs, typically arranged to be on opposing edges, preferably longitudinal edges, of the cleaning substrate. Most preferably, the cuff is attached to the cleaning substrate at an edge of the substrate.

### III. Microcapsules Containing an Active Ingredient

Encapsulation of perfume or other materials in small capsules (or microcapsules), typically having a diameter less than 1000 microns, is well known. Various types of microcapsules for encapsulating perfumes exist, e.g. polymeric particles, cyclodextrin/perfume inclusion complexes, polysaccharide cellular matrices. One type of capsule, referred to as a wall or shell capsule, is preferred in the present invention. Wall or shell capsules comprise a generally spherical hollow shell of insoluble material, typically polymer material, within which the active material of perfume is contained.

The shell capsules may be prepared using a range of conventional methods known to those skilled in the art for making shell capsules such as coacervation, interfacial polymerization and poly-condensation. The process of coacervation typically involves encapsulation of a generally water-insoluble material by the precipitation of colloidal material(s) onto the surface of droplets of the material. Coacervation may be simple e.g. using one colloid such as gelatin, or complex where two or possibly more colloids of opposite charge, such as gelatin and gum arabic or gelatin and carboxymethyl cellulose, are used under carefully controlled conditions of pH, temperature and concentration. Coacervation techniques are described, e.g. in U.S. Pat. No. 2,800,458, U.S. Pat. No. 2,800,457, GB929403, EP385534 and EP376385. It is recognized however that many variations with regard to materials and process steps are possible.

Interfacial polymerization produces encapsulated shells from the reaction of at least one oil-soluble wall forming material present in the oil phase with at least one water-soluble wall forming material present in the aqueous phase. A polymerization reaction between the two wall-forming materials occurs resulting in the formation of covalent bonds at the interface of the oil and aqueous phases to form the capsule wall. An example of a shell capsule produced by this method is a polyurethane capsule.

Polycondensation involves forming a dispersion or emulsion of water-insoluble material e.g. perfume in an aqueous solution of precondensate of polymeric materials under appropriate conditions of agitation to produce capsules of a desired size, and adjusting the reaction conditions to cause condensation of the precondensate by acid catalysis, resulting in the condensate separating from solution and surrounding the dispersed water-insoluble material fill to produce a coherent film and the desired micro-capsules. Polycondensation techniques are described, e.g. in U.S. Pat. No. 3,516,941, U.S. Pat. No. 4,520,142, U.S. Pat. No. 4,528,226, U.S. Pat. No. 4,681,806, U.S. Pat. No. 4,145,184 and GB2073132 and WO 99/17871. It is recognized however that many variations with regard to materials and process steps are possible.

Nonlimiting examples of materials suitable for making shell of the microcapsule include urea-formaldehyde, melamine-formaldehyde, phenol-formaldehyde, gelatin, polyurethane, polyamides, cellulose esters including cellulose butyrate, acetate and cellulose nitrate, cellulse ethers like ethyl cellulose, polymethacrylates.

Other encapsulation techniques are disclosed in MICROENCAPSULATION: Methods and Industrial Applications Edited by Benita and Simon (Marcel Dekker, Inc. 1996).

A preferred method for forming shell capsules useful herein is polycondensation, typically to produce aminoplast encapsulates. Aminoplast resins are the reaction products of one or more amines with one or more aldehydes, typically formaldehyde. Non-limiting examples of suitable amines include urea, thiourea, melamine and its derivates, benzoguanamine and acetoguanamine and combinations of amines. Suitable cross-linking agents in addition to formaldehyde (e.g. toluene diisocyanate, divinyl benzene, butane diol diacrylate etc.) may also be used and secondary wall polymers may also be used as appropriate, as described in the prior art e.g. anhydrides and their derivatives, particularly polymers and co-polymers of maleic anhydride as disclosed in W002/074430.

Preferred shell capsules for use in the present invention are aminoplast capsules, and gelatin capsules. These microcapsules provide optimum performance in combination with perfume compositions. During use, at least a portion of the microcapsules rupture thereby releasing the perfume composition. Furthermore, these microcapsules also provide the best performance when used in combination with an aqueous cleaning composition and/or a cleaning implement as will be further described. During use, at least a portion of the microcapsules rupture thereby releasing the perfume composition. Aminoplast capsules are friable and crumble when abraded. Gelatin capsules furthermore dissolve, at least partially, upon contact with the aqueous cleaning composition, leading to leakage of the perfume composition.

The shell capsules typically have a mean diameter in the range 1 micrometer to 100 micrometers, preferably from 40 micrometers to 90 microns, even more preferably from 50 micrometers to 80 micrometers and most preferably between 60 micrometers to 70 micrometers. The particle size distribution can be narrow, broad or multimodal. The particle size distribution can be narrow, broad or multimodal. Particle size is measured using typical light scattering methods employing instruments such as the Horiba LA-920 Particle Size Analyzer, the Malvern Mastersizer 2000, or Brookhaven's B1-XDC high resolution particle size analyzer.

The active materials used in the core can be a wide variety of materials which one would want to deliver in a controlled manner on to surfaces being treated with the present composition or into the environment surrounding the surfaces. Non-limiting examples of active ingredients include perfumes, flavoring agents, fungicides, odor control agents, antistatic agents, antimicrobial actives, UV protection agents, and the like.

A preferred core material is a perfume composition. The term “perfume composition” is used to mean a composition containing at least 0.1% by weight of one or more perfume raw materials. As is well known, a perfume normally consists of a mixture of a number of perfume materials, each of which has an odor or fragrance. The number of perfume materials in a perfume is typically 10 or more. The range of perfume raw materials used in perfumery is very wide; the materials come from a variety of chemical classes, but in general are water insoluble oils. In many instances, the molecular weight of a perfume material is in excess of 150, but does not exceed 300. Perfumes used in the present invention can be mixtures of conventional perfume materials. Such perfume materials are mentioned, for example, in S. Arctander, Perfume and Flavor Chemicals (Montclair, N.J., 1969), in S. Arctander, Perfume and Flavor Materials of Natural Origin (Elizabeth, N.J., 1960) and in “Flavor and Fragrance Materials—1991”, Allured Publishing Co. Wheaton, 111. USA. A preferred perfume composition is described in copending U.S. Patent Application No. 60/685,932 (P&G case CM2792FP), “A Cleaning wipe comprising perfume microcapsules, a kit and a method of use thereof”, (G. Jordan et al.), filed on May 31^{st}, 2005. Preferably an amount of 10 mg to 500 mg, more preferably an amount of 20 mg to 200 mg, even more preferred an amount of 40 mg to 100 mg, and most preferably an amount of 50 mg to 60 mg of the perfume composition is contained in the microcapsules, on a single wipe.

### IV. Positioning of the Microcapsules on the Cleaning Wipe

The majority of the microcapsules are located adjacent at least one point on the perimeter of the cleaning substrate. As such, proportionally more microcapsules are located near the perimeter than in the center area of the cleaning substrate. When a cleaning substrate is moved over a surface, either by hand or attached to a cleaning implement, more pressure can be applied at an edge of the cleaning substrate, i.e. the edge of the cleaning substrate which is moved in a forward direction. This increased pressure at the edge ensures that more of the microcapsules rupture, and thus better release the active ingredients. This increased pressure at the edge also ensures that more of the microcapsules are transferred to the surface, and thus can continue to deliver the active ingredient, even after the cleaning operation is finished and the cleaning wipe is discarded. Also, there is more friction between the surface and the cleaning substrate at the edge of the substrate which is moved in a forward and backward direction, contributing to the rupturing and transfer of the microcapsules.

Preferably at least 80%, more preferably at least 90%, and most preferably all of the microcapsules on the cleaning wipe are located adjacent at least one point on the perimeter of the cleaning substrate. Preferably, the microcapsules are located in an area defined by the substrate's perimeter and extending up to 60%, preferably up to 50%, more preferably up to 40% of the distance between the center of the cleaning substrate and the perimeter.

The majority, preferably at least 80%, more preferably at least 90% of the microcapsules can be located adjacent one point on the perimeter of the cleaning substrate, or they can be located adjacent two or more points on the perimeter of the cleaning susbtrate. For example, two points on the perimeter may be chosen on opposite edges of the cleaning substrate. In another example, points may be selected on each edge of a cleaning substrate.

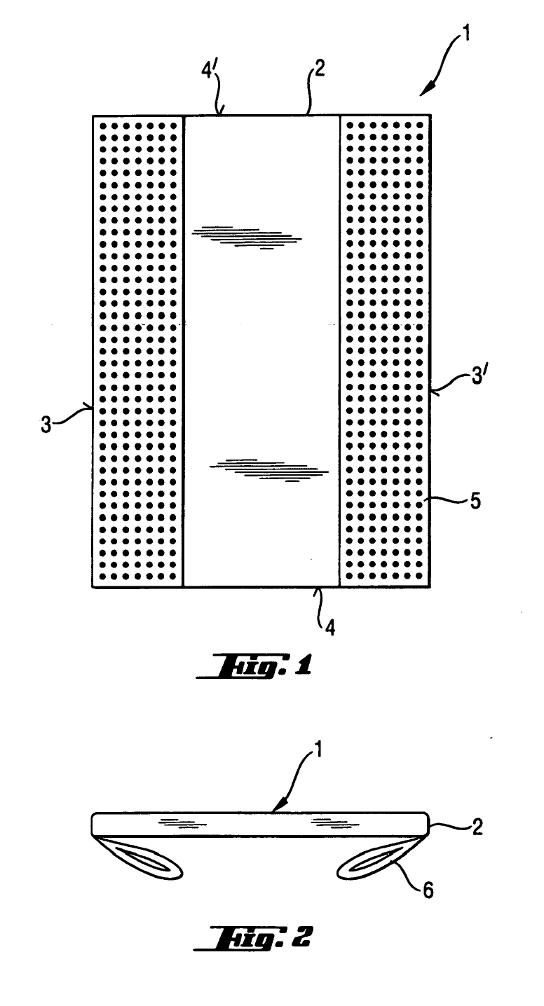

In a preferred embodiment, as shown in FIG. 1, the cleaning substrate (1) comprises two longitudinal edges (3, 3′) connected to each other via two side edges (4, 4′), preferably defining a rectangular area, and the majority of the microcapsules are located adjacent at least one point on a longitudinal edge, at least one point on a side edge, or combinations thereof. Even more preferred, the majority of the microcapsules are located adjacent to two opposing edges, preferably two opposing longitudinal edges, of the cleaning substrate. This is because a cleaning wipe is typically used in a forward and backward motion perpendicular to the longitudinal edges, and therefore more pressure can be applied at the longitudinal edges.

The microcapsules can be dispersed throughout the cleaning substrate, but are preferably attached to the lower surface of the substrate (i.e. the surface which contacts the surface to be cleaned), or when the substrate is multi-layered, to the lower layer. Due to the friction between the wipe and the surface, more microcapsules will rupture, and/or will be transferred to the surface, during use. When the cleaning wipe is used together with a cleaning composition, by attaching the microcapsules to the lower surface or lower layer, the potential of the microcapsules being pulled into the absorbent layer is also reduced.

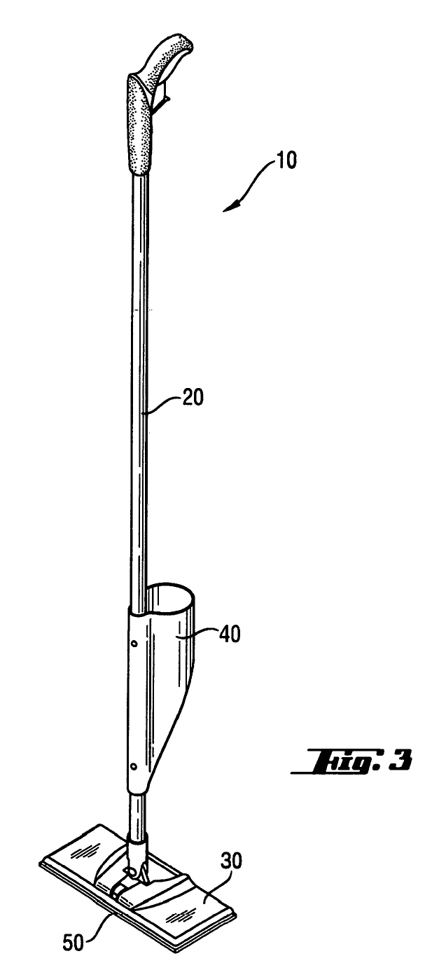

In a preferred embodiment, as previously described and as shown in FIGS. 1 and 2, the cleaning substrate (1) comprises at least one scrubbing strip (5), at least one cuff (6), or a combination thereof. At least a portion of the microcapsules is attached to the scrubbing strip(s) (5), or to the cuff(s) (6). As these scrubbing strip(s) or cuff(s) are attached or located adjacent to the edge of the cleaning substrate, attaching microcapsules to the scrubbing strip(s) or cuff(s) thus achieves the same result, namely that the microcapsules are located adjacent to at least a portion of the cleaning substrate's perimeter (2). In this embodiment, it is preferred that the majority, preferably at least 80%, more preferably at least 90%, or most preferably all of the microcapsules are attached to or incorporated in the scrubbing strip(s) or cuff(s). When cuffs are used, the microcapsules can also be on the cuffs surface, inside the cuffs structure, or a combination thereof. When scrubbing strips are used, the microcapsules can also be on the strip's surface, inside the strip's structure, inbetween the strip and the lower layer of the cleaning substrate (as the strip is completely adhered to the cleaning substrate), or a combination thereof.

### V. Cleaning Kit and Method of Use

The cleaning wipes of the present invention can be used as stand-alone products, but preferably in combination with a cleaning implement, particularly for the cleaning of floor surfaces. Therefore, present invention also provides a cleaning kit for cleaning a surface comprising:
(a) a cleaning implement comprising a handle; and
(b) a cleaning wipe as previously described.

Preferably, the kit further comprises an aqueous cleaning composition suitable for cleaning hard surfaces. Even more preferably, the kit comprises a delivery system capable of delivering the cleaning composition to the surface. In a highly preferred embodiment, the liquid delivery system is attached to the implement's handle, and comprises a container containing the cleaning composition. In use, the cleaning composition is first applied to the surface. The surface is then wiped with the cleaning wipe, attached to the cleaning implement.

Any cleaning composition typically used for cleaning hard surfaces may be used. Examples of cleaning composition suitable for use in the present invention are described in WO 00/27271 (The Procter & Gamble Company). Typically, hard surface cleaning compositions also comprise a perfume composition.

A preferred cleaning implement is shown in FIG. 3 and is marketed as Swiffer WetJet® by The Procter & Gamble Company. The cleaning implement (10) comprises a handle (20) which is attached to a mop head (30), via a pivotable joint. A liquid delivery system (40), containing an aqueous cleaning composition, is attached to the handle (20). As shown in FIG. 3, a cleaning wipe (50) is attached to the underside of the mop head (30).

### VI. EXAMPLES

### Preparation of Microcapsules onto Wipe

The following examples illustrate the preparation of cleaning wipes comprising perfume microcapsules:

### Example 1

70 mg of polyoxymethylene urea microcapsules from Aveka, Inc. Woodbury, Minn. (containing 86%, by weight, of a perfume composition) were evenly distributed inside the cuff of a Swiffer™ Wet Jet™ pad (marketed by the Procter & Gamble Company) using a cotton swab. The cuff can be opened up by gently peeling back the sides exposing the inside of the cuff. The cotton swab was found to be an effective way of controlling the amount and placement of the microcapsules with minimum capsule breakage. After adding the capsules the cuff was re-attached to the pad with adhesive or staples.

### Example 2

A 6% aqueous solution of polyoxymethylene urea microcapsules was prepared using the perfume microcapsules described in Example 1. From this solution, 1.3 g was pipetted evenly along the cuff of a Swiffer™ Wet Jet™ pad (marketed by the Procter & Gamble Company). The pad was allowed to dry overnight at room temperature.

### Performance Evaluation Method

The in-room odor evaluation is conducted in standard grading rooms of dimensions 7 ft (l)×9 ft (w)×9 ft (h) (2.134 m×2.743 m×2.743 m) on a vinyl floor covering. A Swiffer™ Wet Jet™ pad is attached to the mop head of a Swiffer™ Wet Jet™ implement. Comparative example A uses a normal, untreated cleaning pad (which is sold together with the Swiffer™ Wet Jet™ kit). Example 1 is the cleaning pad with perfume microcapsules, as described above. The liquid product solution, which is sold together with the Swiffer™ Wet Jet™ kit, is sprayed evenly across the vinyl floor for 12 seconds. The liquid product solution contains 0.06% of a perfume composition (which is different in composition as the encapsulated perfume composition). Starting towards the outer edge of one corner of the room, the floor is mopped in a back and forth motion until the entire floor surface has been wiped. To simulate a difficult to clean area, the product solution is sprayed in the center of the room for an additional 3 seconds and wiped back and forth 5 times over the sprayed area.

After mopping the room, the mop is removed from the room and the door to the room is shut. Expert graders enter the room at specific time points to grade the room according to the following odor intensity scale:
5=very strong, i.e., overpowering, permeates into nose, almost taste it
4=strong, i.e., very room filling, but not overpowering
3=moderate, i.e., room filling, character clearly recognizable
2=weak, i.e., can be smelled in all corners, still can recognize character
1=very weak, i.e., cannot smell in all parts of the room
0=no odor

### Performance Testing Results

The following data table shows the room odor benefits from using cleaning wipes according to the present invention.

| | Room Odor Grades | | |
|---|---|---|---|
| | 5 minutes after | 30 minutes after | 2 hours after |
| Treatment | application | application | application |
| Comparative | 3.0 | 2.5 | 0.5 |
| example A | | | |
| Example 1 | 3.5 | 3.5 | 2.0 |

All documents cited in the Detailed Description of the Invention are, in relevant part, incorporated herein by reference; the citation of any document is not to be construed as an admission that it is prior art with respect to the present invention.” To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A cleaning wipe suitable for cleaning a surface comprising:
(a) a cleaning substrate; and
(b) microcapsules comprising an active ingredient;
wherein the majority of said microcapsules are located adjacent at least one point on the perimeter of said cleaning substrate.

2. A cleaning wipe according to claim 1, wherein at least 80% of said microcapsules are located adjacent at least one point on the perimeter of said cleaning substrate.

3. A cleaning wipe according to claim 1, wherein said microcapsules are located in an area defined by said perimeter and extending up to 60% of the distance between the center of said cleaning substrate and said perimeter.

4. A cleaning wipe according to claim 1, wherein said cleaning substrate comprises two longitudinal edges connected to each other via two side edges, and wherein said microcapsules are located adjacent at least one point on a longitudinal edge, at least one point on a side edge, or combinations thereof.

5. A cleaning wipe according to claim 1, wherein said microcapsules are located adjacent to two opposing edges of said cleaning substrate.

6. A cleaning wipe according to claim 1, wherein said microcapsules are located adjacent to two opposing longitudinal edges of said cleaning substrate.

7. A cleaning wipe according to claim 1, wherein said microcapsules are attached to the lower surface of said cleaning substrate, to the inner structure of said cleaning substrate, or combinations thereof.

8. A cleaning wipe according to claim 1,
wherein said cleaning substrate further comprises at least one cuff, at least one scrubbing strip, or combinations thereof; and
wherein at least a portion of said microcapsules are attached to, or incorporated into said at least one cuff and/or said at least one scrubbing strip.

9. A cleaning wipe according to claim 1, wherein said cleaning substrate comprises at least one scrubbing strip; and wherein at least a portion of said microcapsules is attached to said scrubbing strip, is located between said cleaning substrate and said scrubbing strip, or combinations thereof.

10. A cleaning wipe according to claim 1, wherein said microcapsules are rupturable under friction; dissolve, at least partially, upon contact with an aqueous composition; or combinations thereof.

11. A cleaning wipe according to claim 1, wherein said microcapsules have a shell comprising aminoplast, gelatin or combinations thereof.

12. A cleaning wipe according to claim 1, wherein said microcapsules have a mean diameter of from 1 micrometer to 100 micrometer.

13. A cleaning wipe according to claim 1, wherein said active ingredient comprises a perfume composition.

14. A cleaning wipe according to claim 1, wherein said cleaning substrate comprises nonwoven fibers.

15. A cleaning kit suitable for cleaning a surface comprising:
(a) a cleaning implement; and
(b) a cleaning wipe according to claim 1.

16. A cleaning kit according to claim 15, wherein said cleaning kit further comprises an aqueous cleaning composition.

17. A method of cleaning a surface comprising the step of contacting said surface with a cleaning wipe according to claim 1.

18. A method of cleaning a surface according to claim 17, wherein said cleaning wipe is attached to a cleaning implement.

19. A method of cleaning a surface according to claim 18, wherein the cleaning implement comprises a system for delivering an aqueous cleaning composition, and wherein the method comprises the step of delivering said cleaning composition to said surface.
